(19) United States
(12) Patent Application Publication
(10) Pub. No.: US 2013/0164073 A1
(43) Pub. Date: Jun. 27, 2013

(54) Movable buckle device of a file box

(71) Applicant: Chun Yuan Chang, Taipei (TW)

(72) Inventor: Chun Yuan Chang, Taipei (TW)

(21) Appl. No.: 13/337,095

(22) Filed: Dec. 24, 2011

(51) Int. Cl. B42F 13/00; B42F 15/00; B42F 13/16

(52) U.S. Cl. 402/75; 402/77

(57) ABSTRACT

A movable buckle device of a file box contains a movable buckle device of a file box comprised of an upper cover, a lower cover, a side lid, wherein the side lid includes a groove in which two through holes are defined on an upper end and a lower end of the groove respectively and two orifices are defined on two sides of the groove individually, each orifice is used to insert a hook member, the hook member includes a first stop piece and a second stop piece formed on one side of the first stop piece, the second stop piece includes an elongated aperture 33 formed thereof; the groove is served to receive a binder seat, and the binder seat includes two openings defined on two ends thereof respectively to correspond to the two through holes of the groove individually.

### BACKGROUND OF THE INVENTION

1. Field of the Invention

The present invention relates to a movable buckle device of a file box.

2. Description of the Prior Art

As shown in FIGS. 5 and 6, a conventional file box 10 includes a side lids 11 fixed on an upper end and a lower end thereof respectively, and a hanging member 15 extending and retracting in a groove 12 of the side lid 11, the hanging member 15 is fixed by a limiting member 14 of the groove 12, and a retaining potion 16 of the hanging member 15 retains with a projection 13 so that the hanging member 15 extends outward or retract inward to be fixed. In operation, the file box 10 is hanged on a document cart by using the hanging member 15 to distribute the file boxes 10.

However, the hanging member 15 can not support the file boxes strongly, and it is easy to break or bend. When the hanging member 15 and the limiting member 14 connect together, the hanging member 15 disengages from the file box 10 easily as drawing the file box 10 forcefully.

The present invention has arisen to mitigate and/or obviate the afore-described disadvantages.

### SUMMARY OF THE INVENTION

The primary object of the present invention is to provide a movable buckle device of a file box that is capable of hanging the file box movably.

Another object of the present invention is to provide a movable buckle device of a file box that is capable of distributing a plurality of file boxes conveniently and pushing the hook member into the side lid quickly.

### BRIEF DESCRIPTION OF THE DRAWINGS

FIG. 1 is a perspective view showing the assembly of a movable buckle device of a file box according to a preferred embodiment of the present invention;

FIG. 2 is a perspective view showing the exploded components of the movable buckle device of the file box according to the preferred embodiment of the present invention;

FIG. 3 is a plan view showing the operation of the movable buckle device of the file box according to the preferred embodiment of the present invention;

FIG. 4 is a perspective view showing the operation of the movable buckle device of the file box according to the preferred embodiment of the present invention;

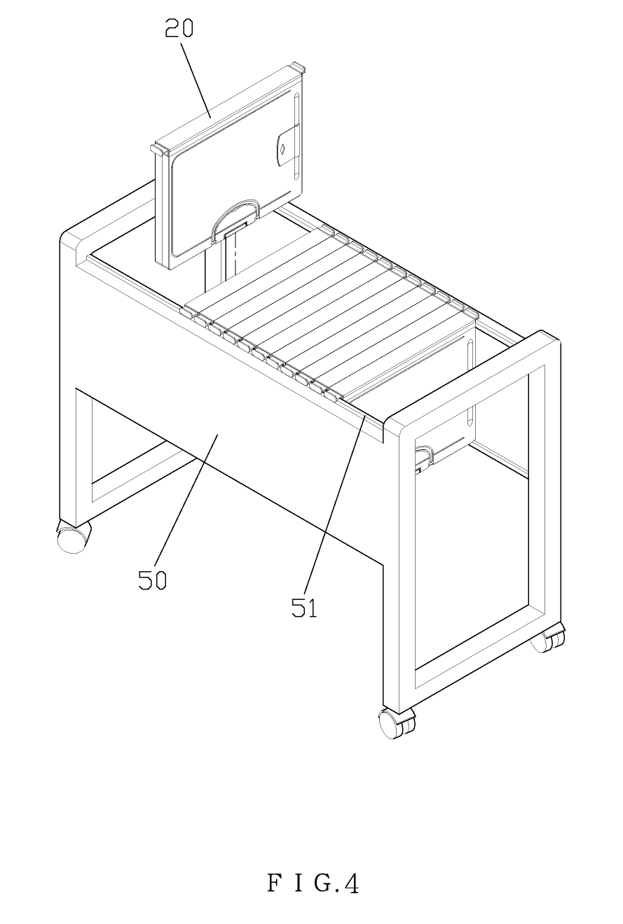

FIG. 5 is a perspective view showing of a conventional file box;

FIG. 6 is a plan view showing the operation of a conventional file box.

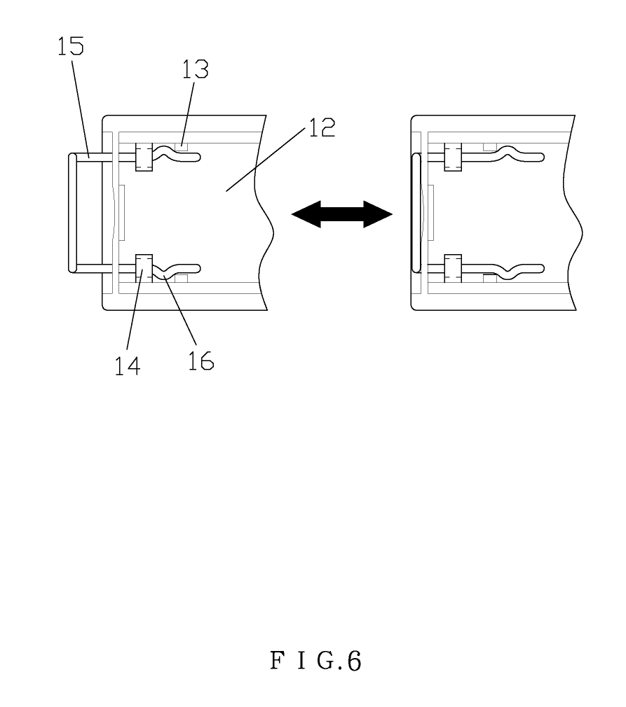

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

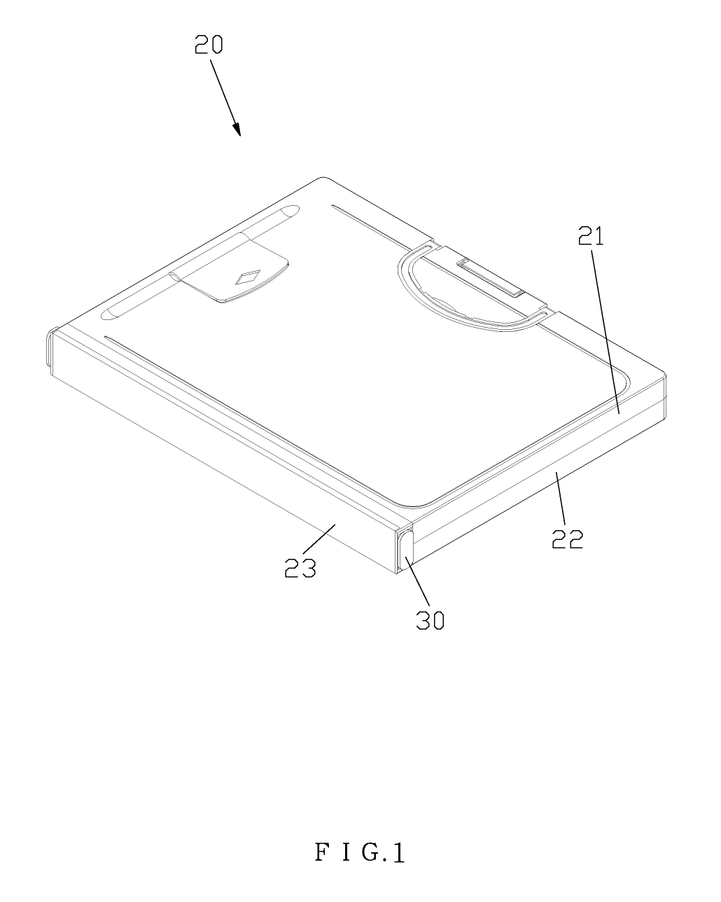

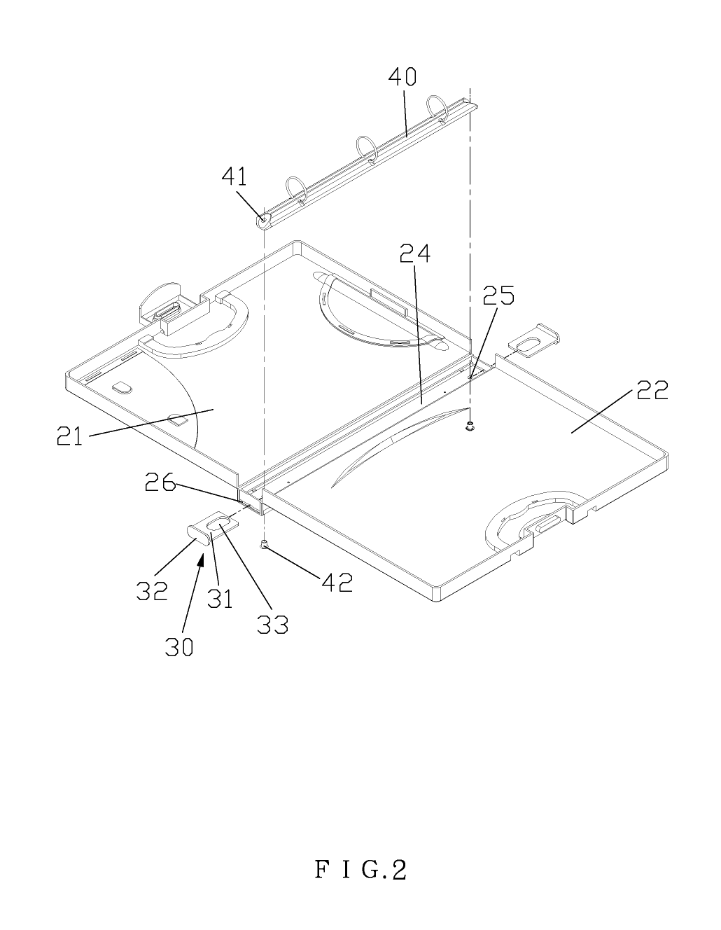

Referring to FIGS. 1 and 2, a movable buckle device of a file box 20 in accordance with a preferred embodiment of the present invention is comprised of an upper cover 21, a lower cover 22, a side lid 23, wherein the side lid 23 includes a groove 24 in which two through holes 25 are defined on an upper end and a lower end of the groove 24 respectively and two orifices 26 are defined on two sides of the groove 24 individually, each orifice 26 is used to insert a hook member 30, the hook member 30 includes a first stop piece 31 and a second stop piece 32 formed on one side of the first stop piece 31, the second stop piece 31 includes an elongated aperture 33 formed thereof; the groove 24 is served to receive a binder seat 40, and the binder seat 40 includes two openings 41 defined on two ends thereof respectively to correspond to the two through holes 25 of the groove 24 individually.

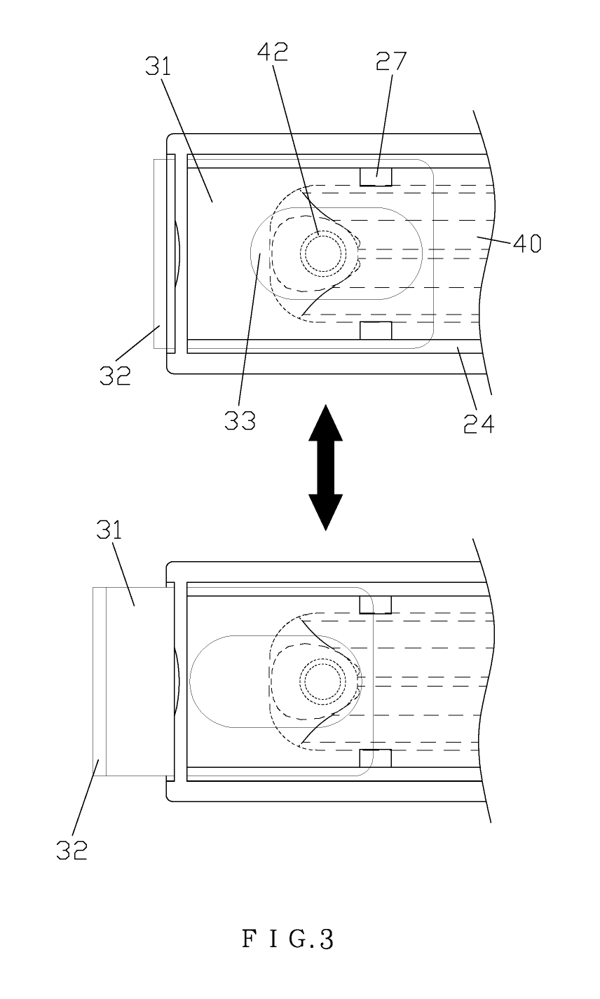

Referring to FIGS. 2 and 3, the first stop piece 31 of the hook member 30 is inserted into the orifice 26, and the second stop piece 32 is limited on an outer side of the groove 24, the groove 24 also includes a limiting member 27 to position the first stop piece 31, and the elongated aperture 33 of the first stop piece 31 is in response to each of the two through holes 25 and each of the two openings 41 so that when the binder seat 40 retains with the groove 24 of the file box 20, the first stop piece 31 of the hook member 30 is limited between the binder seat 40 and the groove 24, and a bolt element 42 is applied to connect the binder seat 40, the hook member 30, and the groove 24 together, the hook member 30 moves in a space between the elongated aperture 33 and the bolt element 42 to extend and retract on two outer sides of the groove 24, thereby enabling to hang the file box 20 movably.

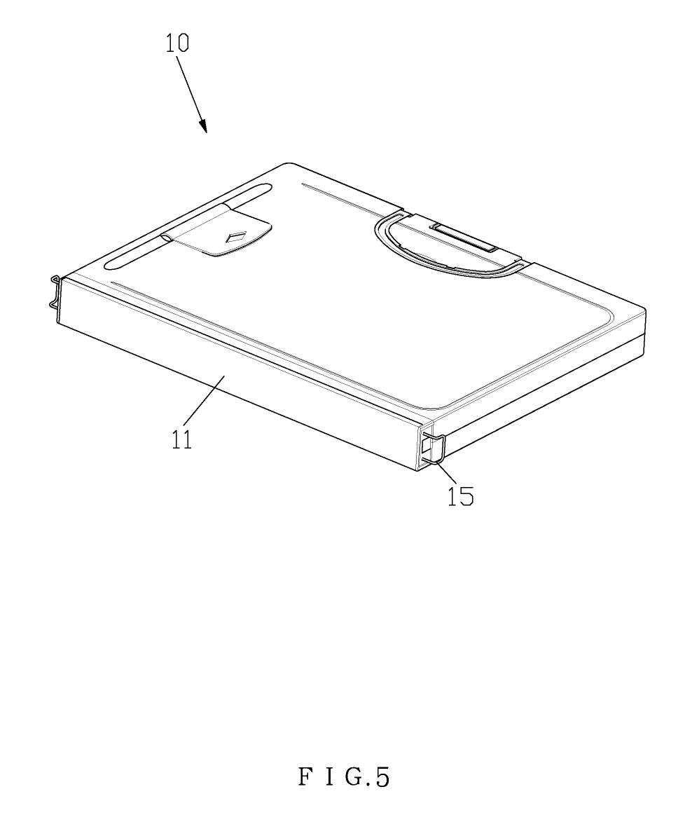

Referring further to FIG. 5, as hanging the file box 20, the hook member 30 is pulled outward to hang the file box 20 between two peripheral straps 51 of a document cart 50, thus distributing a plurality of file boxes 20 conveniently and pushing the hook member 30 into the side lid 23 quickly.

While we have shown and described various embodiments in accordance with the present invention, it is clear to those skilled in the art that further embodiments may be made without departing from the scope of the present invention.

What is claimed is:

1. A movable buckle device of a file box comprising
a movable buckle device of a file box comprised of an upper cover, a lower cover, a side lid, wherein the side lid includes a groove in which two through holes are defined on an upper end and a lower end of the groove respectively and two orifices are defined on two sides of the groove individually, each orifice is used to insert a hook member, the hook member includes a first stop piece and a second stop piece formed on one side of the first stop piece, the second stop piece includes an elongated aperture 33 formed thereof; the groove is served to receive a binder seat, and the binder seat includes two openings defined on two ends thereof respectively to correspond to the two through holes of the groove individually;
wherein the first stop piece of the hook member is inserted into the orifice, and the second stop piece is limited on an outer side of the groove, and the elongated aperture of the first stop piece is in response to each of the two through holes and each of the two openings so that when the binder seat retains with the groove of the file box, the first stop piece of the hook member is limited between the binder seat and the groove, and a bolt element is applied to connect the binder seat, the hook member, and the groove together, the hook member moves in a space between the elongated aperture and the bolt element to extend and retract on two outer sides of the groove.

2. The movable buckle device of the file box as claimed in claim 1, wherein the groove also includes a limiting member to position the first stop piece.
